(19) United States
(12) Patent Application Publication
(10) Pub. No.: US 2010/0264739 A1
(43) Pub. Date: Oct. 21, 2010

(54) Modular adaptive power matrix

(76) Inventor: Monte Errington, Palm City, FL (US)

Correspondence Address: Ober, Kaler, Grimes & Shriver;Attorneys at Law, 120 East Baltimore Street, Baltimore, MD, 21202-1643, US

(21) Appl. No.: 12/386,265

(22) Filed: Apr. 15, 2009

(51) Int. Cl. H02J 3/38

(52) U.S. Cl. 307/80

(57) ABSTRACT

A modular adaptive power management center integrating control and management of multiple electrical power sources such as locally generated solar or wind power, connections to an electrical utility service provider, battery power, and others. The system increases system efficiency by monitoring load requirements and matching available power sources in real time. A wall mounted rack system houses a system backplane and a main system microprocessor. The backplane accepts plug-in power modules including power converters each dedicated to managing one of various energy sources such as local wind or solar sources, as well as utility grid connections and battery backup systems. The system also includes a backup battery bank and a battery power module to control charge/discharge activity of the batteries. A variety of user interfaces are provided including via a local LCD display, LED indicators, and remote access and monitoring through an Internet connection and browser window. The modular nature of the design allows a homeowner/user to “plug-in” additional modules as new power sources become available.

### CROSS-REFERENCE TO RELATED APPLICATION(S)

The present application derives priority from U.S. provisional application Ser. No. 61/214,215 filed 15 Apr. 2008.

### BACKGROUND OF THE INVENTION

1. Field of the Invention

The present invention relates to methods and units for integrating and controlling multiple renewable power sources, batteries and a utility grid connection to maximize efficient energy use. Different modules employ different methods in the unit to overcome issues that are predominate in today's renewable energy field. These include overloading of buss currents, redundant reliable operation, and thermal transfer of excessive heat.

2. Description of the Background

Traditionally, residential and commercial power was derived primarily from a utility power grid. However, power consumers are increasingly relying on alternative power sources such as solar panels, wind turbines, fuel cells and generators to augment the local utility electricity supply. To implement a multiple-source system, close attention must be paid to the various power sources and how best to deliver power from the power sources to multiple power-consuming loads.

For example, FIG. 1 shows a typical modern scenario with a residence deriving power from an electric utility through a grid, plus a rooftop-mounted wind turbine and a backup battery bank. However, almost all power sources have a limited capacity to supply power to a load, and this necessitates some form of power management to select the most appropriate power source(s) to meet a demand that varies widely over time.

The concept of integrating and controlling multiple alternative power sources, batteries and a utility grid connection to maximize efficient energy use is detailed by a variety of references in the prior art. Specifically, U.S. patent application Ser. No. 11/837,888 filed by Craig H. Miller on Aug. 13, 2007 discloses an “Optimized Energy Management System” with a microcomputer housed in a metal racking system with a battery backup and user interface coupled to an electric utility grid as well as to one or more alternative energy sources such as solar, wind, micro-hydro, fuel cell etc. as well as to the buildings load distribution circuits. Based on weather forecast, load forecast, energy pricing and other information provided, the microcontroller optimizes energy use by utilizing the most economical source(s) of energy, scheduling loads when possible and selling excess generating capacity back to the grid when available. During outages the system may utilize the available battery.

Similarly, U.S. Pat. No. 7,274,975 issued to Craig H. Miller on Sep. 25, 2007 and application Ser. No. 11/276,337 filed by Brian Golden, et al. on Feb. 24, 2006 both manage power by establishing an energy budget and monitoring energy use in a building over time, from which future consumption patterns can be forecast in light of weather forecast, historical data, battery charge levels etc. This forecast is compared with availability and cost information for various sources including grid and non-grid (solar, wind, etc.) to identify expected use in excess of the budget. The system may then take steps to limit electrical loads in order to meet the budget.

U.S. Pat. No. 6,452,289 issued to Geoffrey Lansberry, et al. on Aug. 13, 2007 and assigned to SatCon Technology Corp. discloses a “Grid Linked Power Supply.” The system consists of an inverter, at least one distributed energy source (such as photovoltaic, wind turbine, etc.) to meet non-peak load demand, a connection to a public utility grid to meet peak power demand requirements and a converter for regulating delivery of power from the various power sources. The system can prioritize usage of the grid versus stored power or local generating means based on a number of parameters and regulates the voltage across the system to provide clean power to the residence. The system may also manage a battery backup system.

To facilitate the addition of new power sources to an existing system, the concept of a modular power control system capable of expansion by the introduction of additional plug-in units has been utilized. For example, U.S. Pat. No. 6,738,692 issued to Lawrence A. Shienbein, et al. on May 18, 2004 and assigned to Sustainable Energy Technologies discloses a “Modular Integrated Power Conversion and Energy Management System.” The system consists of a controller and power converter for distributed energy generation on multiple scales including on a residential/small commercial scale (10-250 kW). The system includes multiple independent power modules along with inverter, converter, rectifier, communications, user interface and control modules on a shared backplane. Each power module includes memory that can be polled by the backplane to identify its design parameters in order to provide “plug-and-work” functionality. Multiple power sources are contemplated including utility grid connections, solar, wind, turbine, diesel and battery.

Likewise, U.S. Pat. No. 7,227,278 issued to Richard A. Realmutto, et al. on Aug. 13, 2007 and assigned to Nextek Power Systems, Inc. discloses a “Multiple Bi-Directional Input/Output Power Control System.” The system consists of a network of functional blocks housed in a single enclosure providing DC power to one or more DC loads from multiple power sources. The digital processor of the Power Control Unit has the ability to change the operating characteristics of the system to optimize use of alternative energy sources such as solar, wind turbine, fuel cell or engine driven cogeneration in conjunction with power from a utility grid. The system can convert power to/from AC as necessary although most loads are driven by DC power.

Despite the foregoing efforts, the foregoing references do not provide a scalable modular approach with modules capable of handling both existing and future renewable power demands with different renewable technologies. What is needed is a system flexible enough to accommodate different variations of multiple energy inputs and outputs applications, and to interface known renewable sources as well as unknown as well.

The present invention is an Adaptive Power Matrix that solves these and other issues that have not been addressed in the prior arts.

### SUMMARY OF THE INVENTION

Accordingly, it is an object of the invention to provide a modular Adaptive Power Matrix flexible enough to manage different energy inputs (both known renewable sources as well as unknown, e.g. solar, wind turbine, fuel cells, etc.), and to provide reliable output power to widely varying loads by monitoring load requirements and matching available power sources in real time.

It is another object to provide a modular Adaptive Power Matrix as described above that utilizes multiple priority bus configurations in conjunction with redundant power modules to improve the overall efficiency of the units. The thermal management systems also increase the overall life expectancy of the overall units.

In accordance with the foregoing objects, an Adaptive Power Matrix is described in the context of a preferred embodiment that is a modular power management center integrating control and management of multiple electrical power sources such as locally generated solar or wind power, plus connection to an electrical utility service provider. The system increases system efficiency by monitoring load requirements and matching available power sources in real time. A wall mounted rack system houses a system backplane and a main system microprocessor. The backplane accepts plug-in power modules including power converters each dedicated to managing one of various energy sources such as local wind or solar sources, as well as utility grid connections and battery backup systems. The system also includes a backup battery bank and a battery power module to control charge/discharge activity of the batteries. The backplane accommodates additional power modules as system requirements grow or change. The modules and controllers are “smart” and can monitor load demands and source power levels in order to ensure that loads are not effected by variations in power from the various sources. Specifically, all the plug-in power control modules use a digital signal processor (DSP) to provide internal circuit control within each module independent of the system backplane, the main system microprocessor, or any other plug-in module. Each module has a front panel display with control switches for direct module control and monitoring. A front panel RS232 communication port on each module allows each plug-in module to communicate status with the main system microprocessor, and indirectly to outside computers monitoring via the main system microprocessor and its communications ports.

A variety of user interfaces are provided including via a local LCD display, LED indicators, and/or by remote access and monitoring through an Internet connection and browser window. The modular nature of the design allows a homeowner/user to “plug-in” additional modules as new power sources become available. The system also contemplates a battery backup system to supply critical circuits when no other source is available, thereby providing the user the ability to monitor and control load consumption on a circuit by circuit basis. As the varying inputs and loads increase and decrease the Adaptive Power Matrix uses Multiple Power Matrix Tracking techniques to internally adjust to the most effective power priority buss's requirements along with the redundant power modules working with the thermal power transfer router for a unique renewable energy control system. In addition, the commonality of sub-assemblies used in the various modules minimizes overall manufacturing costs and insure the shortest possible delivery times for each type of power control module.

### BRIEF DESCRIPTION OF THE DRAWINGS

Other objects, features, and advantages of the present invention will become more apparent from the following detailed description of the preferred embodiment and certain modifications thereof, in which:

FIG. 1 shows a typical modern scenario with a residence deriving power from an electric utility through a grid, plus a rooftop-mounted wind turbine and a backup battery bank.

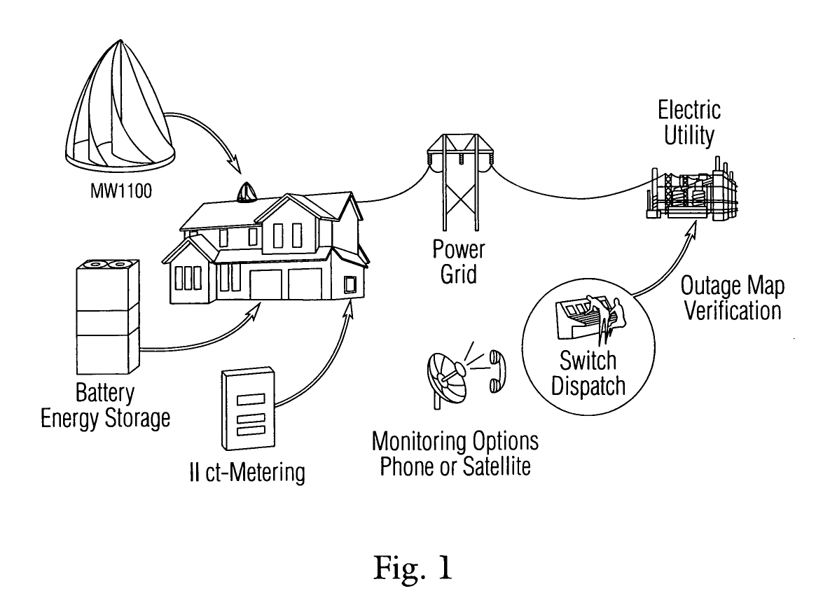

FIG. 2 is a block diagram of a modular adaptive power matrix according to an embodiment of the present invention.

FIG. 3 is a side cross-section of the chassis/backplane 10, which generally includes an inner mounting bracket 12 for mounting on a wall or other vertical support, an enclosed terminal chamber 14 attached to the chassis 10 for enclosing a bus terminal rail 16, a rectangular skeletal mounting frame 18 protruding forwardly of the enclosed terminal chamber 14, and an enclosure body 20 supported around the mounting frame 18.

FIG. 4 is a front view of the chassis/backplane 10 with one APM module 30 inserted therein.

FIG. 5 is a block diagram of the modular adaptive power matrix software communication flow.

FIG. 6 is a block diagram of the Solar Power Converter Module.

FIG. 7 is a block diagram of the Battery Controller Module.

FIG. 8 is a block diagram of the Fuel Cell Controller Module.

FIG. 9 is a block diagram of the Wind Power Controller Module.

FIG. 10 is a block diagram of the AC Inverter Module.

FIG. 11 is a schematic block diagram of the communications bus and I/O bus architecture providing data communications between the modules 30 and the main system controller 20 over a multiple priority bus.

### DETAILED DESCRIPTION OF THE PREFERRED EMBODIMENTS

The present invention a modular Adaptive Power Matrix comprising a plurality of “smart” modular source modules connected in a chassis/backplane to manage different energy inputs and to provide reliable output power to widely varying loads by monitoring load requirements and matching available power sources in real time. Each smart module uses Multiple Power Matrix Tracking techniques to control the process of stepping up or down any higher or lower input voltages and which bus would perform the most efficiently.

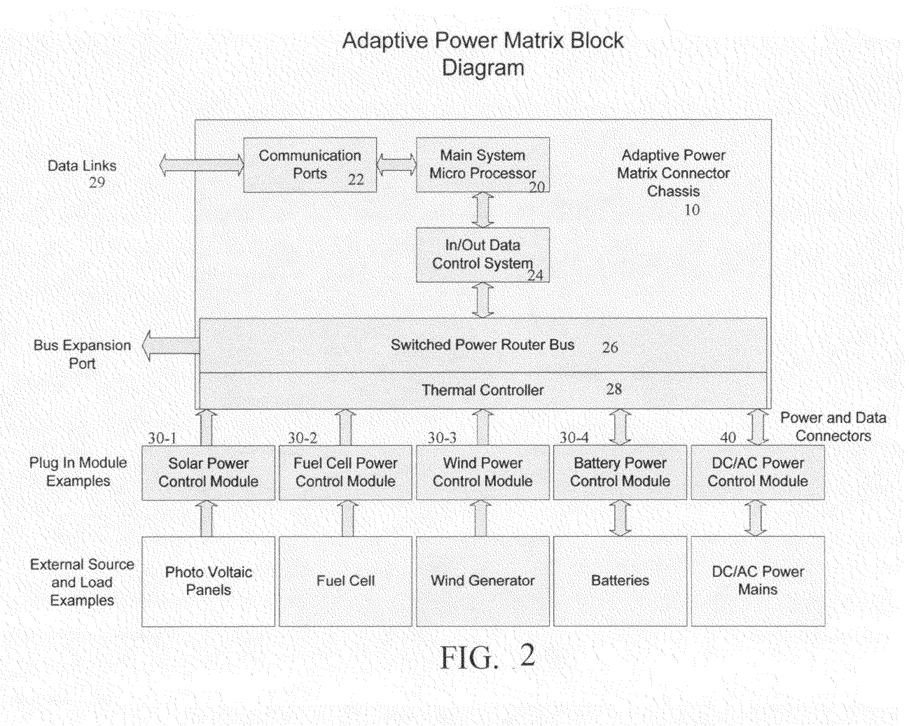

FIG. 2 is a block diagram of a modular adaptive power matrix according to an embodiment of the present invention. The system generally employs a chassis 10 including a housing and backplane (to be described) that accept plug-in power modules 30-1 . . . n including power converters each dedicated to managing one of various energy sources such as local photo-voltaic panels, fuel cells, wind sources, as well as a battery backup system and connection to a utility grid. The chassis 10 accommodates any number of additional power modules as system requirements grow or change. The modules 30-1 . . . n are “smart” and can monitor load demands and source power levels. The modules 30-1 . . . n communicate through an input/output data control system 24 with a main system microprocessor 20 in the chassis 10 that integrates control and management of the multiple electrical power sources by monitoring load requirements and matching available power sources in real time, thereby increasing system efficiency. It is important that the commonality of sub-assemblies used in the various types of specialized modules 30-1 . . . n help to minimize overall manufacturing costs and insure the shortest possible delivery times for each type of power control module. More specifically, all the plug-in power control modules 30-1 . . . n use a digital signal processor (DSP) to provide internal circuit control within each module independent of the system backplane, the main system microprocessor 20, or any other plug-in module. Each plug-in module 30-1 . . . n communicates its status with the main system microprocessor 20 and indirectly to outside computers via data links 29 that are used to monitor the main system microprocessor 20 and its communications ports, and to make monitoring available by remote access through an Internet connection and browser window. The input/output data control system 24 is the interface between the main system microprocessor 20 and the other system components and additional chassis 10 components, if any. Thus, the input/output data control system 24 may be a conventional network data communication hub. A thermal controller 28 is also provided within the chassis 10 to monitor and control temperature conditions therein and to provide feedback to the main system microprocessor 20. The thermal controller 28 overcomes the thermal dynamics of being exposed to high outside temperatures. During the peak operation of modules 30-1 . . . n, a certain amount of heat is produced by losses throughout the components in the system. The thermal controller identifies these hot spots and transfers the heat by means of a cooling system, preferably an aqueous non-conducting fluid cooling system that carries the heat to a heat removal unit.

The main system controller 20 hosts and runs Multiple Power Matrix Tracking (MPMT) software that monitors the voltages, currents, and temperatures within the different modules 30-1 . . . n to manage the best solutions. The modular nature of the design allows a homeowner/user to “plug-in” additional modules as new power sources become available. As the varying inputs and loads increase and decrease the main system microprocessor 20 uses Multiple Power Matrix Tracking techniques to internally adjust to the most effective power priority bus requirements along with the redundant power modules 30-1 . . . n working with the thermal controller 28 for a unique renewable energy control system.

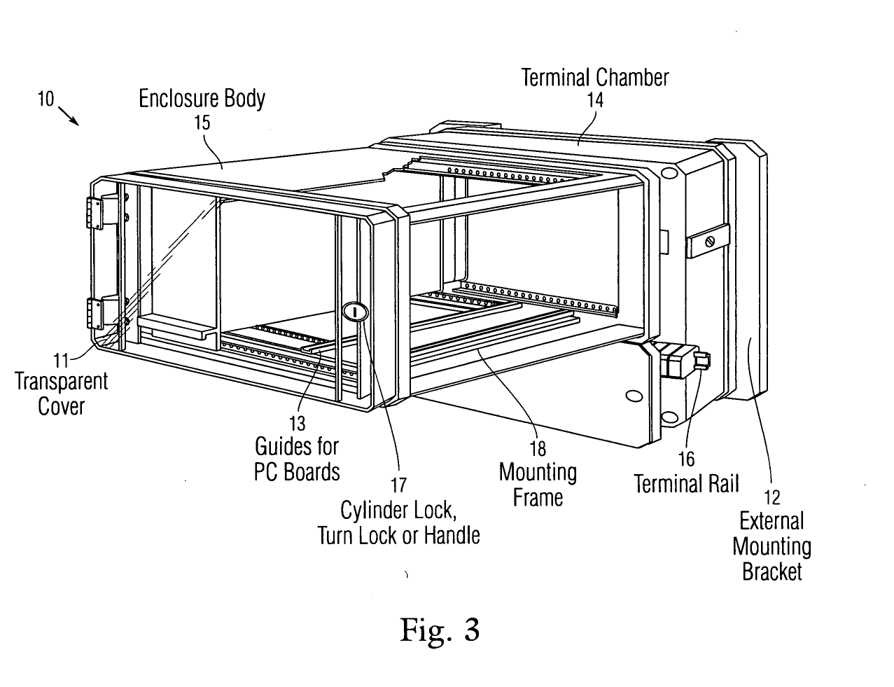

FIG. 3 is a side cross-section of the chassis/backplane 10, which generally includes an inner mounting bracket 12 for mounting on a wall or other vertical support, an enclosed terminal chamber 14 attached to the chassis 10 for enclosing a bus terminal rail 16, a rectangular skeletal mounting frame 18 protruding forwardly of the enclosed terminal chamber 14, and an enclosure body 15 supported around the mounting frame 18. The interior of the chassis/backplane 10 is accessible through a pivoting transparent cover 11 that locks shut via a conventional cylinder lock 17. Within the mounting frame 18 a plurality of PC board guideslots 13 are aligned therein. This configuration allows APM modules 30-1 . . . n to be installed in the guideslots 13 enclosed within the wall-mounted chassis 10 with secure power connections from sources & to loads.

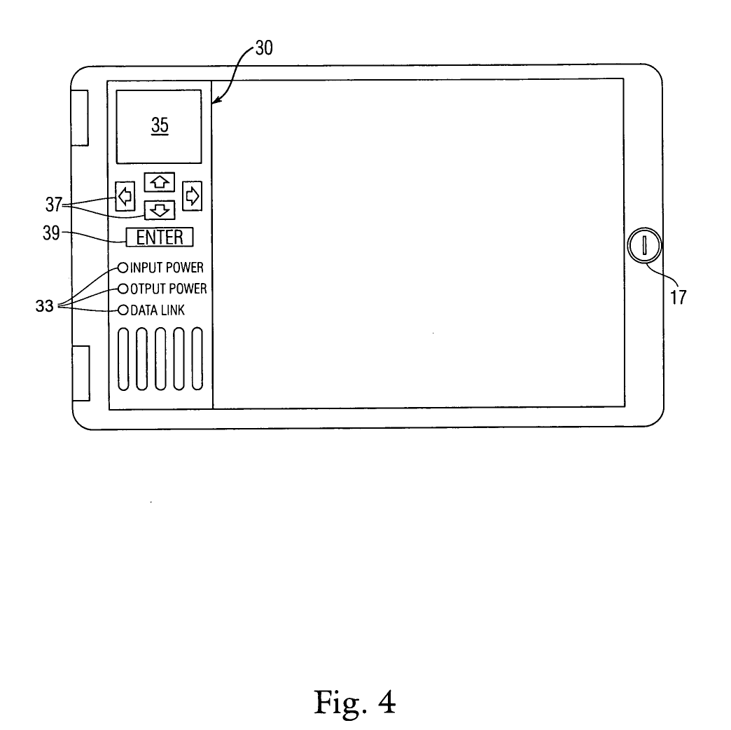

FIG. 4 is a front view of the chassis/backplane 10 with one APM module 30 inserted therein. Each APM module 30-1 . . . n slides into the chassis 10 onto the PC board guideslots 13. As many PC board guideslots 13 as desired may be provided to ensure scalability to grow as power requirements grow or as needs change, and a user may insert as many APM modules 30-1 . . . n as needed into the available PC board guideslots 13. Each APM module 30-1 . . . n includes three LEDs 33 for indicating Input Power, Output Power, and Data Link, respectively. In additon, a small LCD Display 35 is provided with an underlying menu selection panel of arrow buttons 37, and an Enter button 39 for user selection of menu choices appearing on the LCD Display.

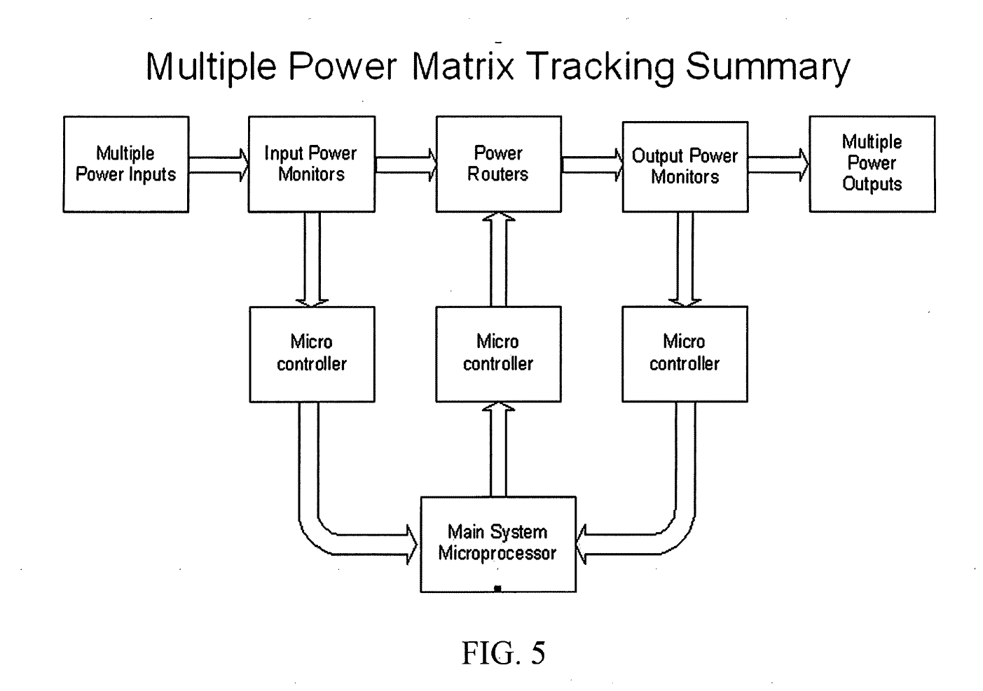

FIG. 5 is a block diagram of the modular adaptive power matrix software communication flow. The main system microprocessor 20 runs Multiple Power Matrix Tracking (MPMT) software that requires key monitor points (input, output, and power router) to establish and maintain overall system parameters by switching the power routing devices. The software utilizes feedback controls and sensors to the microprocessor 20 for the most efficient system operation. Specifically, the software relies on a geometric linear matrix of equations that control the power inputs, power outputs, power bus router, and thermal controller 28. This source code defines priorities with iterative statements received through the in/out data control system. The first part of operation is to change all of the input voltages with high efficiency to a common bus voltage of 200 VDC or higher voltage. This ensures that there is a common voltage available on the bus for the multiple power load outputs. With a common voltage available, the microprocessor 20 can then control the power to the multiple power outputs needed for efficient system operation. The microprocessor 20 uses iterative power ratio algorithms to determine changing demands on the system, maintaining the quality of service provided. The software compares power available to power required, then signals the appropriate modules 30-1 . . . n to accommodate the power load requirements. With this technique the system maintains a constant power delivery and consistency of performance throughout changing output power loads.

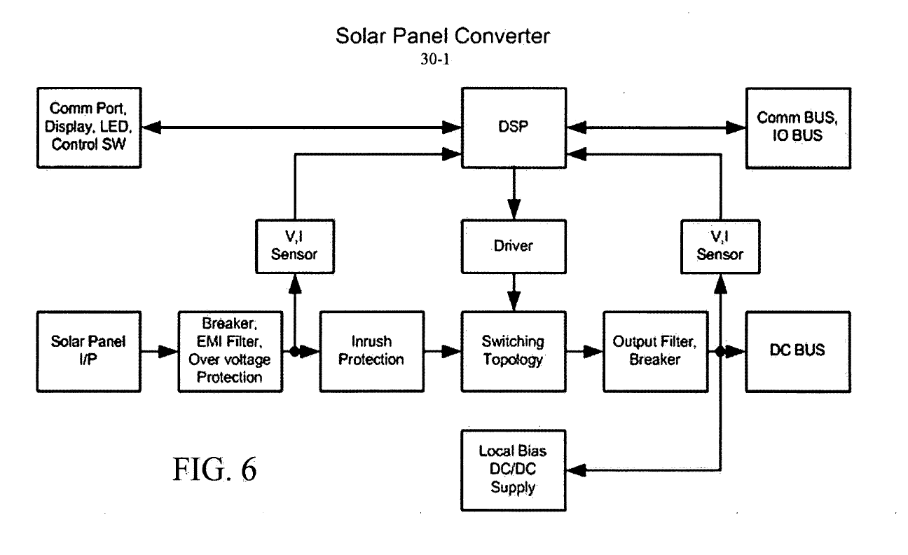

FIG. 6 is a block diagram of the Solar Power Converter Module 30-1. The array of solar power panels (aka photo voltaic cells) that provide DC power to the module 30-1 may be configured by the user to provide a wide range of DC voltage and current to meet the customer load demand. External to the APM Module 30-1, a photo-voltaic panel I/P is connected to a circuit breaker/EMI filter for overvoltage protection. The filtered output is then sent to a protective transient voltage surge suppressor which attenuates (reduces in magnitude) random, high energy, short duration electrical power anomalies caused by utilities, atmospheric phenomena, or inductive loads. The filtered output is also sensed by a voltage and current meter. The meter provides voltage (V) and amperage (I) readings which are communicated to a digital signal processor (DSP). The DSP output is fed to a driver circuit which drives a high-frequency power switching circuit to provide the rated output voltage and current to the load. A suitable output filter network removes the switching transients from the output voltage to provide stable voltage and current to the output load. The output voltage and current are also monitored by a voltage and current meter which provides output voltage (V) and amperage (I) readings to digital signal processor (DSP). Also, the filtered output power is tapped off to a local DC/DC Power supply for powering the module 30-1. The DC/DC Power supply outputs dual 5 vdc and 12 vdc power for powering the on-board circuitry. The high-frequency power switching circuit may comprise a bank of FETs, and the DSP effectively forms a pulse width modulated (PWM) amplifier using the FETS as a network of switching elements for controlling the directional flow of output current into a load. Thus, the DSP outputs a signal to control the driver circuit, which outputs a pulse train that controls the functioning of the electronic FET switching components. Known PWM techniques are employed to step down any higher input voltages, which can range drastically, thereby providing a controlled, and regulated lower working output voltage. The regulated output is fed out from the APM Module 30-1 through a fuse to the DC bus, where it can be selectively applied to one or more loads. The output voltage and current are monitored by the DSP to maintain system operating parameters. Note that each APM Module 30-1 . . . n also contains a serial, USB or Ethernet communication port for external data bus communication. This allows a remote computer to monitor and record events as the system is operational phase.

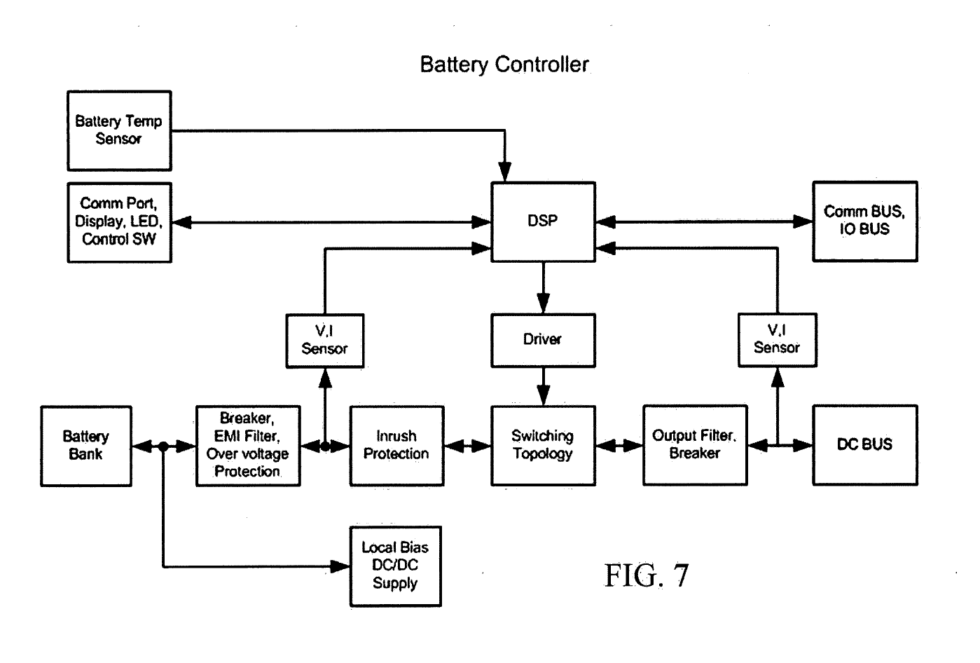

FIG. 7 is a block diagram of the Battery Controller Module 30-4, which operates very similarly to the foregoing. An external battery bank provides DC power to the module 30-4 through a circuit breaker/EMI filter for overvoltage protection. The filtered output is then sent to a protective transient voltage surge suppressor which attenuates (reduces in magnitude) random, high energy, short duration electrical power anomalies caused by utilities, atmospheric phenomena, or inductive loads. The filtered output is also sensed by a voltage and current meter. The meter provides voltage (V) and amperage (I) readings which are communicated to a digital signal processor (DSP). The DSP output is fed to a driver circuit which drives a high-frequency power switching circuit to provide the rated output voltage and current to the load. A suitable output filter network removes the switching transients from the output voltage to provide stable voltage and current to the output load. The output voltage and current are also monitored by a voltage and current meter which provides output voltage (V) and amperage (I) readings to digital signal processor (DSP). In this case the battery output power is tapped off to a local DC/DC Power supply for powering the module 30-4. The DC/DC Power supply outputs dual 5 vdc and 12 vdc power for powering the on-board circuitry. The high-frequency power switching circuit and PWM operation of the DSP are as described above to provide a controlled, and regulated lower working output voltage. The regulated output is fed out from the APM Module 30-4 through a fuse to the DC bus, where it can be selectively applied to one or more loads. Again the APM Module 30-4 . . . n contains a serial, USB or Ethernet communication port for external data bus communication so that a remote computer can monitor and record events as the system is operational phase. One addition to the Battery Controller Module 30-4 is a battery temperature sensor connected to the DSP for monitoring temperature conditions to prevent overheating. Due to the volatile nature of some types of DC power storage batteries, it is necessary to reduce the power drain if excessive battery heating is detected. Since the temperature sensor is mounted proximate the batter(ies), it is also capable of maintaining the proper battery charge status when the battery is not the only source of power to the system. The DSP in this case is programmed with one of various types of battery charging algorithms to maintain and extend the life of deep cycle batteries.

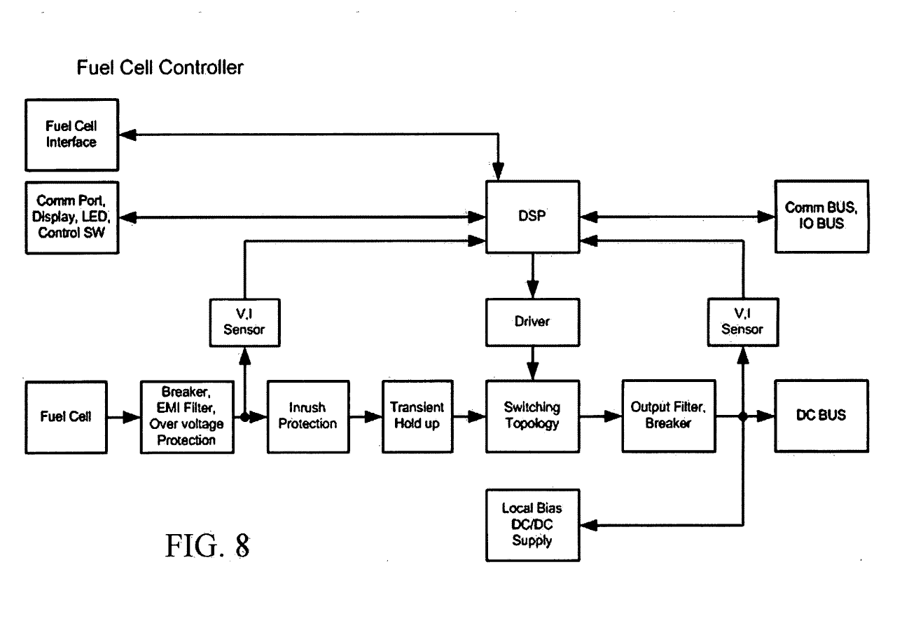

FIG. 8 is a block diagram of the Fuel Cell Controller Module 30-2, which again operates similarly to the foregoing. The fuel cell(s) provides DC power to the module 30-2 through a circuit breaker/EMI filter for overvoltage protection. The filtered output is then sent to a protective transient voltage surge suppressor which attenuates (reduces in magnitude) random, high energy, short duration electrical power anomalies caused by utilities, atmospheric phenomena, or inductive loads. The filtered output is also sensed by a meter that provides voltage (V) and amperage (I) readings which are communicated to a digital signal processor (DSP). The DSP output drives the high-frequency power switching circuit to provide the rated output voltage and current to the load. The output voltage and current are filtered, and monitored by a voltage and current meter which provides output voltage (V) and amperage (I) readings to digital signal processor (DSP). for powering the module 30-4. The high-frequency power switching circuit and PWM operation of the DSP are as described above to provide a controlled, and regulated lower working output voltage. The output is tapped off to a local DC/DC Power supply. The regulated output is fed out from the APM Module 30-2 through a fuse to the DC bus, where it can be selectively applied to one or more loads, and a serial, USB or Ethernet communication port allows external data bus communication. Instead of monitoring battery temperature as done in the battery controller 30-4, fuels cells invariably include a data interface which can be used directly by the DSP to monitor the status of the fuel cells. Also note the addition of a transient hold-up circuit between the inrush protection circuitry and the main switching circuits. The transient holdup circuit may be a conventional storage capacitor circuit to provide interim power due to the time delay of fuel cells when adapting to changing power loads.

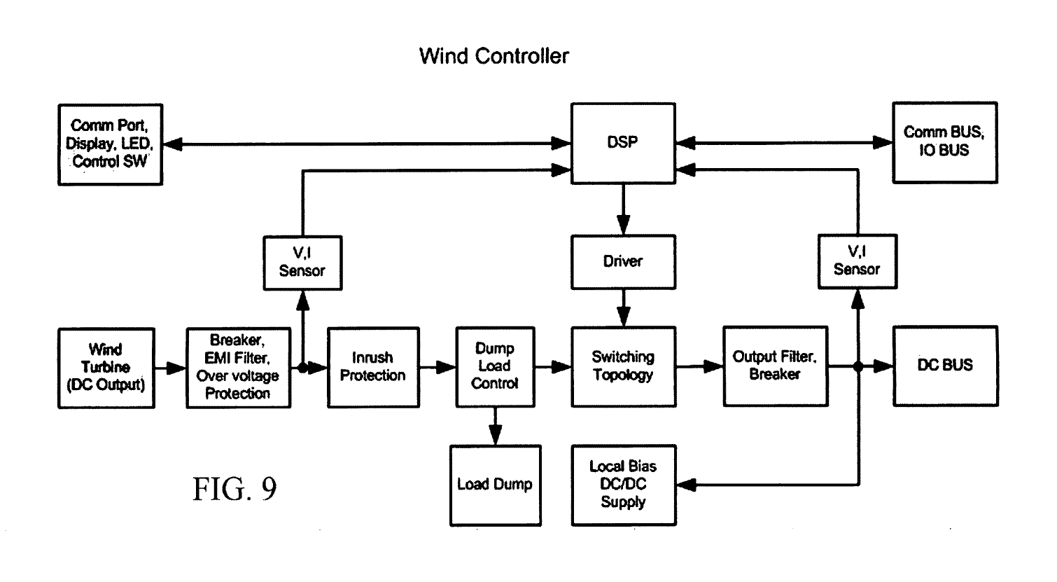

FIG. 9 is a block diagram of the Wind Power Controller Module 30-3, again very similar to the other foregoing modules. However, the Wind Power Controller Module 30-3 employs an additional dump load control circuit and load dump prior to the switching circuitry. Some wind generators get their efficiency by utilizing a higher output voltage, and extreme wind conditions may produce excess power that could exceed the rating of the wind controller module. As a protective measure, the dump load control circuit and load dump prior to the switching circuitry has the ability to “dump” the excess power prior to the switching circuits. The excess power may be used to charge storage batteries, to maintain fuel cell components, or dissipated if not needed. The dumping of excess power from the wind turbine prevents the turbine from going into unstable operation or a complete shut down of the wind turbine. There are a variety of known dump load control circuits that use zener diodes, or voltage division circuits in combination with a control circuit to sense the need for a load dump.

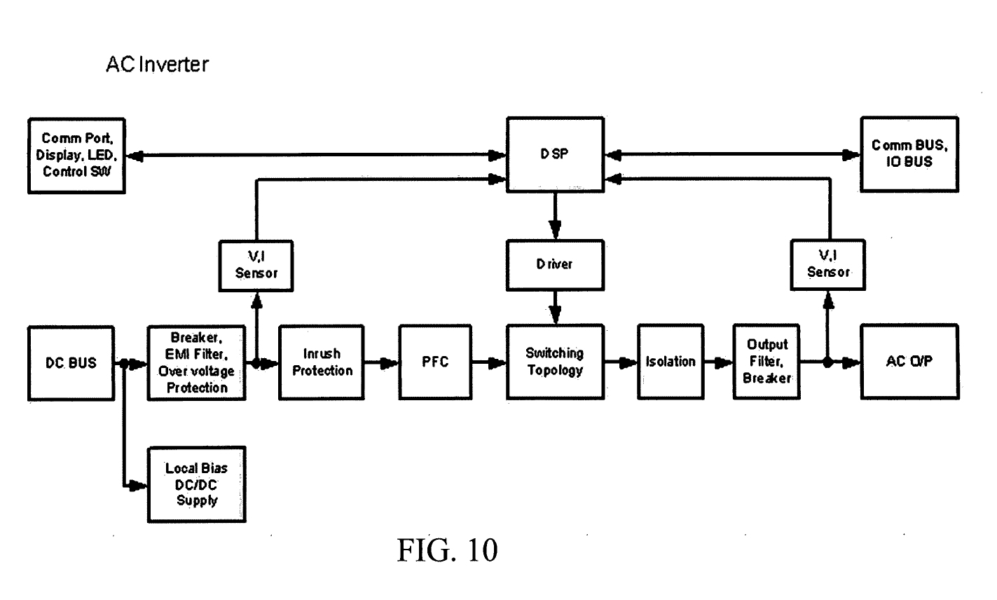

FIG. 10 is a block diagram of the AC Inverter Module 40, again very similar to the other foregoing modules. However, the AC Inverter Module 40 adds two new features to the other module basic designs. The use of power-factor correction PFC is required to optimize the efficiency of the conversion from direct current to alternating current at the appropriate voltage and line frequency for use worldwide. The switching topology in the AC inverter may be configured for single-phase, split-phase, or multi-phase AC output power. In addition, an isolation circuit insures a safe connection to the AC mains for communities that allow excess locally-generated power to be sold back to the local power company. In operation, main power is provided by the power grid to the AC Inverter Module 40, which acts as a converter to convert the AC power to DC and provide high voltage to the back plane, which is then converted to AC by an AC inverter for use. Note that if the grid side APM Module 40 fails the alternate energy Modules 30-1 . . . n can take over.

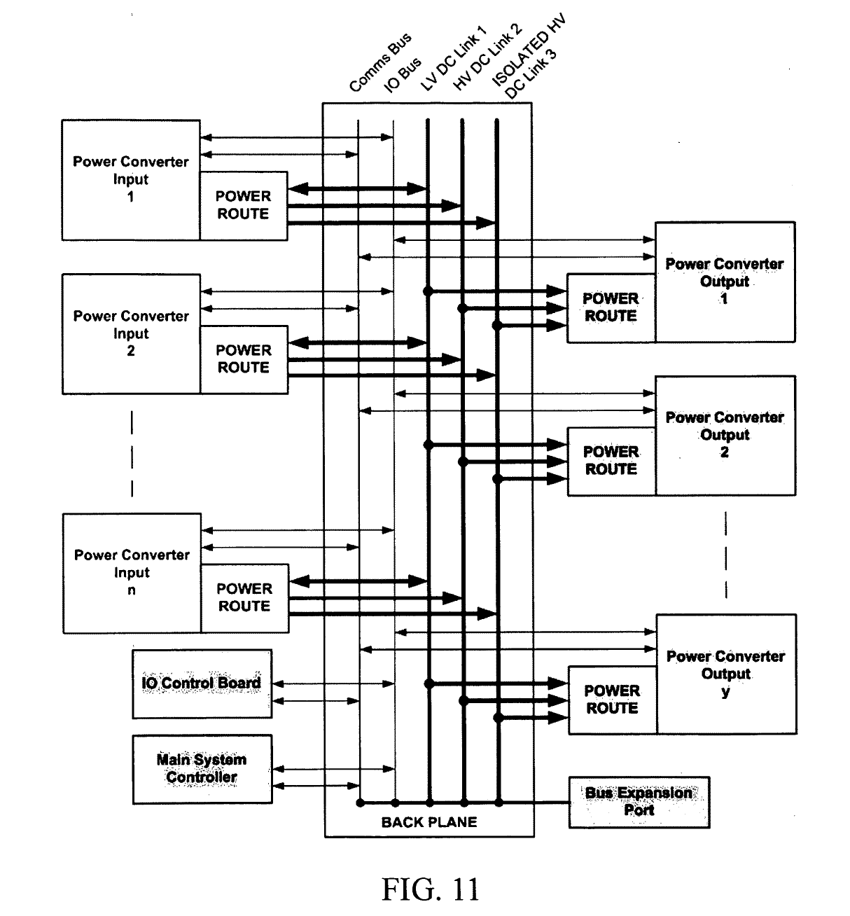

FIG. 11 is a schematic block diagram of the communications bus and I/O bus architecture providing data communications between the modules 30-1 . . . n and the main system controller 20 over a multiple priority bus. At the top, the communications bus and I/O bus provide the path of data communications between the modules 30-1 and the main system controller 20. The low-voltage DC bus is linked to system batteries that are used to provide power to the DC bias supplies on all modules 30-1 . . . n and is connected to battery charging circuitry. One or more high-voltage DC power buses are available to provide power to the various types of output modules. The number of high-voltage DC power buses is determined by the total desired output power load[s] of the system. Using high-voltage and low-current on these power buses improves internal system efficiency. The high-voltage buses are electrically-isolated from the main battery ground for safety concerns. The Multiple Priority Bus configuration uses lower priority busses (Comms Bus, IO Bus) for the battery chargers, system bias supplies and Main System Controller 30. Higher voltage busses handle 300-400 volts DC (LV DC Link 1, ISOLATED HV

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. An Adaptive Power Matrix for integrated control and management of multiple power sources including solar and wind power, an electrical utility service provider, and a battery bank, comprising:
a wall mounted chassis including a system backplane and a main system microprocessor running software;
a plurality of plug-in power modules insertable into said chassis, each dedicated to managing one of said various energy sources, each of said plug-in power modules including a digital signal processor (DSP) in data communication with said main system processor;
whereby said software monitors the redundant power modules to adjust to the most effective power configuration.
